(19) United States
(12) Patent Application Publication
(10) Pub. No.: US 2014/0036680 A1
(43) Pub. Date: Feb. 6, 2014

(54) Method to Allocate Packet Buffers in a Packet Transferring System

(71) Applicant: Futurewei Technologies, Inc., Plano, TX (US)

(72) Inventors: Iulin Lih, San Jose, CA (US); Chenghong He, Shenzhen (CN); Hongbo Shi, Xian (CN); Naxin Zhang, Singapore (SG)

(73) Assignee: Futurewei Technologies, Inc., Plano, TX (US)

(21) Appl. No.: 13/955,400

(22) Filed: Jul. 31, 2013

Related U.S. Application Data
(60) Provisional application No. 61/677,518, filed on Jul. 31, 2012.
(60) Provisional application No. 61/677,884, filed on Jul. 31, 2012.

(51) Int. Cl. H04L 12/801

(52) U.S. Cl. CPC H04L 47/12
USPC 370/235

(57) ABSTRACT

A method comprising receiving a credit status from a second node comprising a plurality of credits used to manage the plurality of allocations of storage space in a buffer of the second node, wherein each of the plurality of allocations are dedicated to a different packet type, instructing the second node to use the credit dedicated to a second priority packet type for storing a first priority packet type, wherein the first priority is higher than the second priority, and wherein the credit status reflects the credits for the first priority packet type having reached a minimum value, and transmitting the first priority packet to the second node.

### CROSS-REFERENCE TO RELATED APPLICATIONS

The present application claims priority to U.S. Provisional Patent Application No. 61/677,518 entitled “A Method to Allocate Packet Buffers in a Packet Transferring System” and U.S. Provisional Patent Application No. 61/677,884 entitled “Priority Driven Channel Allocation for Packet Transferring”, both of which are by Iulin Lih, et al., filed on Jul. 31, 2012, and are incorporated herein by reference as if reproduced in their entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Packet transferring systems may be utilized to share information among multiple nodes, in which a node may be any electronic component that communicates with another electronic component in a networked system. For example, a node may be a memory device or processor in a computing system (e.g., a computer). The computing system may have a plurality of nodes that need to be able to communicate with one another. A node may employ data buffers to store incoming packets temporarily until they can be processed. Packets may be forwarded from one node to another across physical links, which may be divided into virtual channels. These virtual channels may further be allocated into a number of different virtual channel classes with different priority levels for packets. However, buffering may be limited by uneven traffic distribution among different priority packets. For example, buffer space allocated to a specific packet type or priority may be oversubscribed thereby causing congestion for this packet type while buffer space allocated to a different packet type may be underutilized thereby resulting in inefficient use of buffer resources. The overall quality of service (QoS) may be degraded due to high latency during data transmission. Additionally, the throughput and link utilization may be drastically reduced if one or more of the nodes are oversubscribed, and its packet queues back up and consume a large fraction of the available buffers.

### SUMMARY

In one embodiment, the disclosure includes a method comprising receiving a credit status from a second node comprising a plurality of credits corresponding to allocations of storage space in a buffer of the second node, wherein each of the plurality of allocations are dedicated to a different packet type, and wherein the credits for each packet type are used to manage the plurality of allocations, instructing the second node to use the credit dedicated to a second priority packet type for storing a first priority packet type, wherein the first priority is higher than the second priority, and wherein the credit status reflects the credits for the first priority packet type has reached a minimum value, and transmitting the first priority packet to the second node.

In another embodiment, the disclosure includes a method comprising receiving a credit status from a second node comprising a plurality of credits corresponding to allocations of storage space in a buffer of the second node, wherein a portion of the plurality of allocations are a shared allocation dedicated to a plurality of packet types, wherein a portion of the plurality of allocations are a plurality of private allocations, wherein each of the plurality of private allocations are dedicated to different packet types, and wherein the credits are used to manage the plurality of allocations, instructing the second node to use a shared credit for storing a first priority packet of a first priority type, wherein the credit status reflects the credits for the first priority packet type has reached a minimum value, and transmitting the first priority packet to the second node.

In yet another embodiment, the disclosure includes an apparatus comprising a buffer, a receiver configured to receive a credit status from a second node comprising a plurality of credits corresponding to allocations of storage space in a second buffer of the second node, wherein a portion of the plurality of allocations are a shared allocation dedicated to a plurality of packet types, wherein a portion of the plurality of allocations are a plurality of private allocations, wherein each of the plurality of private allocations are dedicated to different packet types, and wherein the credits are used to manage the plurality of allocations, and a transmitter coupled to the second buffer via the buffer and configured to transmit an instruction to the second node to use the credit dedicated to a second priority packet type for storing a first priority packet type, wherein the first priority is higher than the second priority, and wherein the credit status reflects the credits for the first priority packet type has reached a minimum value.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an interconnected network system embodiment.

FIG. 2 illustrates an example buffer partition together with the corresponding buffer credits.

FIG. 3 shows an embodiment of an allocation of a buffer.

FIG. 4 illustrates an example of data communication between two nodes.

FIG. 5 is a flowchart of an embodiment of a priority driven packet storage method.

FIG. 6 is a schematic diagram of an embodiment of a packet transferring system.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are methods and apparatuses that provide enhanced buffer allocation and management. In order to foster efficiency in data buffers, a packet transferring system may be enhanced by adopting a policy that allows a transmitter to determine when packets of one packet type may use private buffer spaces reserved for other packet types to ensure that certain packet types are serviced and not blocked at the expense of servicing other packet types. This upstream transmission control by the transmitter may then be used for high priority traffic or to accommodate an influx of a specific packet type in an uneven distribution of traffic. In this system, a portion of the private buffer spaces may be reserved for exclusive use by the corresponding packet type. Hence, this approach may allow different packet types to utilize private buffers that may be available for storage, wherein a plurality of corresponding virtual channels may be utilized for transport between buffers. Additionally, a system may adopt a policy that may partition data buffer space into private buffer spaces reserved for specific packet types and shared buffer space that may be used by any packet type. In this system, the transmitter may determine when packets of one packet type may use either shared buffer space or private buffer spaces reserved for other packet types. The shared buffer space may be further partitioned in to class shared buffer spaces reserved for packet classes comprised of designated groupings of packet types. Thus, buffer and/or channel allocations may improve packet buffer performance by, for example, accommodating uneven traffic distributions.

One model for packet transfer uses shared and private buffers of fixed sizes, which may work well under the assumption that each packet type is generated in roughly equal numbers. However, this system may be inefficient for handling uneven distributions of traffic. For example, if there is an increased amount of traffic for packet type 2, then other private buffers may sit idle or be underutilized while private buffer 2 becomes overloaded. Thus, there may be a need to enhance buffer allocation and management to better handle uneven distributions of traffic among different packet types.

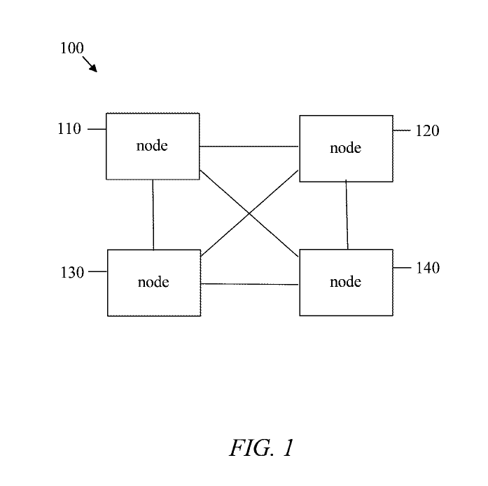

FIG. 1 illustrates an embodiment of an interconnected network system 100. The system 100 may comprise a plurality of nodes, such as node 110, node 120, node 130, and node 140. As illustrative examples, a node may be implemented as a distinct electronic component in a system on a chip (SoC), or a node may be a single chip in a plurality of chips such as in a motherboard for a computer system. That is, the nodes may be located in different chips or within components on the same chip for inter-chip or intra-chip communication, respectively. Although only four nodes are shown for illustrative purposes, any number of nodes may be used in the system. The system 100 is shown as a full mesh for purposes of illustration; however, the buffer schemes disclosed herein are not limited to any particular system topology or interconnection. For example, the nodes may be organized as a ring, or any other structure with the nodes arranged in any order.

In system 100, nodes 110-140 are interconnected as a full mesh such that each node may communicate directly with any other node in the system with a single hop. A node may have bidirectional communication capability as it may both transmit and receive packets from other nodes. A transmitting node and a receiving node, which may be referred to hereafter as a transmitter and a receiver, respectively, may each use data buffers to store packets temporarily. For example, node 110 may be a transmitter with a buffer, which holds packets that are to be sent to another node. Node 110 may forward these packets from the buffer to node 120, which may be the receiver. The packets may subsequently be stored in a buffer at node 120 until they are processed.

A packet may be classified according to its packet type. For example, a packet may be classified as a data packet or a control packet. Data packets may contain the data relevant to a node or process such as a payload, while control packets contain information needed for control of a node or process. Data packets may be further classified by latency requirements of a system. A voice call or a video chat may require low latency in order for satisfactory streaming, while a web download may tolerate high latency.

Additionally, different data and control packets may be divided by priority. Control packets that initiate a transaction may be given a lower priority than control packets that finish a transaction. For example, a cache coherence transaction may enable communication between an L1 cache and an L2 cache in order to update and maintain consistency in cache contents. The first step in this transaction may comprise a request to an L2 cache (e.g., from a node other than L1) to perform a write. The L2 cache may send a “snoop” request to the L1 cache to check cache contents and update contents if needed. The L1 cache may then send a “snoop” response to confirm that it is done, and the transaction may be completed with a final response from the L2 cache to confirm the write. In cache coherence transactions, higher priority may be given to a packet that is about to finish a transaction while a packet that is starting the transaction may be assigned a lower priority. Packets for intermediate steps of the transaction may correspond to intermediate priority levels. The various packets of different types and priority levels may be stored in distinct buffer spaces.

A data buffer may be divided into a shared buffer and a plurality of private buffers. A shared buffer may be occupied by different packet types, while a private buffer may be allocated for a specific packet type. Virtual channels may be utilized to forward packets from one buffer at a transmitting node to another buffer at a receiving node. A virtual channel may refer to a physical link between nodes, in which the bandwidth is divided into logical sub-channels. Each channel may be assigned to a private buffer, in which a specific packet type may be stored. The packets may correspond to different packet types (e.g., data or control) as well as different priority levels (e.g., high or low priority).

A shared buffer may be susceptible to head-of-line (HOL) blocking, which involves a packet at the head of a transmission queue that a node is unable to transmit. This behavior prevents transmission of subsequent packets until the blocked packet is forwarded. In order to alleviate HOL limitations, packets may be scheduled to fill designated buffers based on priority allocation. Conventional private buffers may only be used by an assigned packet type; however, these buffers may be limited by reduced transmission bursts. Private buffers may also contribute to low buffer availability due to a buffer credit system.

A buffer credit system may be implemented to ensure that a receiver has enough space to accept a packet before transmission. A buffer credit may be sent to a transmitter and set to a value indicating a unit of memory. One buffer credit may be issued per unit of buffer space at a receiver. For example, when a packet is sent to the receiver's buffer, the buffer count (or counter) at the transmitter may be decremented. When a packet is moved out of the receiver's buffer, the buffer count may be incremented. Once the buffer count has been reduced to a minimum value (e.g., zero), the transmitter may know that a particular buffer is full and may wait to send more packets until a ready message is received.

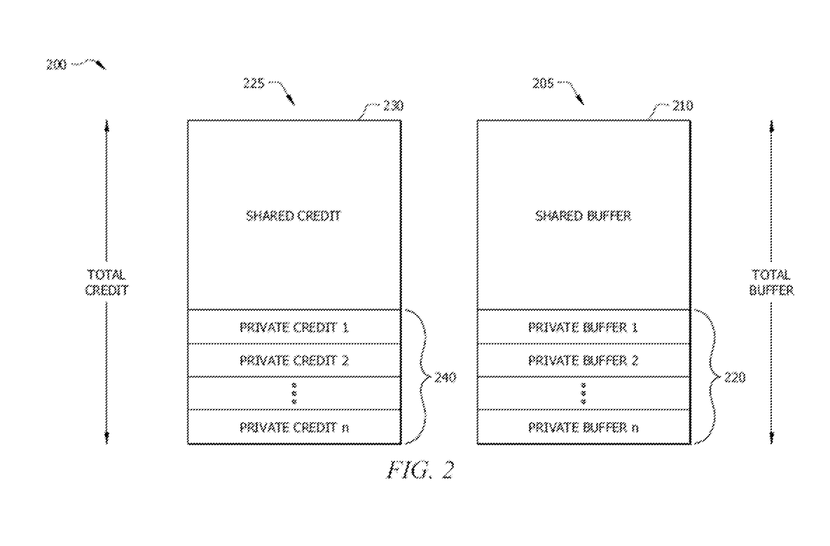

FIG. 2 shows an example partition of a buffer 205 together with the corresponding buffer credits 225. The buffer 205 together with the buffer credits 225 may be referred to as a buffer mapping 200. As illustrated in FIG. 2, a buffer 205 may be partitioned into a shared buffer space or region 210 (referred to as a shared buffer) and a plurality of n private buffer spaces or regions 220 (referred to as private buffers), where n≧2. The shared buffer 210 may comprise unallocated space that may be used to store any type of packet whereas the private buffers 220 may each be allocated to store a different packet type of a specific packet type (e.g., priority level). The buffer regions in the buffer 205 may be implemented in a receiving node, such as a node in FIG. 1's interconnected system 100. Data traffic between a transmitter and a receiver may be classified into various packet types, wherein a packet type may be specified according to a priority level of a packet. Suppose n=4 in a system where there are four packet types. For example, a packet of highest priority may be assigned to packet type 1, while a packet of lowest priority may be designated as packet type 4. Packet types 2 and 3 may comprise packets of intermediate priority levels accordingly. Each traffic type may be provided with an allocated portion of a private buffer 220. In a conventional buffer system, packet type 1 may be stored in private buffer 1, packet type 2 may be stored in private buffer 2, and so forth. A shared buffer 210 may be employed by any packet type if its associated private buffer is full. For example, if private buffer 2 has exceeded its memory limit, type 2 packets may then be stored in the shared buffer as long as there is space.

A receiving node may save packet data of a given type to the section of the private buffer 220 allocated for that data type. To determine buffer availability in a buffer 205, there may be associated buffer credits at a transmitting node as shown in FIG. 2, in which there may be one credit assigned per unit of memory (e.g., a specific number of bytes) as required in an implementation. The buffer credit system may comprise shared credits 230 and a plurality of n different private credits 240. The transmitter may maintain a count of private credits 240 for each data type, corresponding to private buffers 220. Similarly, shared credits 230 for a shared buffer 210 may be stored. These buffer credits may be employed to determine the status of a receiver's buffer.

As packets are moved in and out of a shared buffer, the shared credit value may be adjusted accordingly. In an embodiment, a receiver such as node 110 may determine that it is ready to process a packet that is currently stored in one of its private buffers (e.g., private buffer 220). The receiver may then move the packet out and send a message to notify a transmitter of the open space. This message may be a credit for however many units of memory left unoccupied by that packet.

Ultimately, a transmitter may keep track of buffer credits, in terms of decrementing and incrementing the values accordingly. Suppose one of the private buffers 220 occupies 1 kilobyte (KB) of memory with one credit issued per byte (e.g., 1028 credits for 1028 bytes or 1 KB). A transmitter may initially have 1028 credits and may decrement by one as each byte is sent to a receiver. After 1028 bytes of packets have been sent for a specific packet type, a buffer credit count for the corresponding private buffer may be zero. As packets are moved out of an associated receiver's buffer, a transmitter may receive credits back from the receiver and increment the buffer credit count accordingly. The buffer credit system may allow a transmitter to monitor buffer availability to determine whether or not a buffer for a particular node is ready to accept incoming packets.

The buffer partitioning shown in FIG. 2 may be implemented using physical or logical partitions. That is, the buffer 205 may not in fact be partitioned into regions. Rather, the buffer 205 may be managed as a shared pool of memory by the various packet types. The buffer may be managed according to credits allocated to the various packet types.

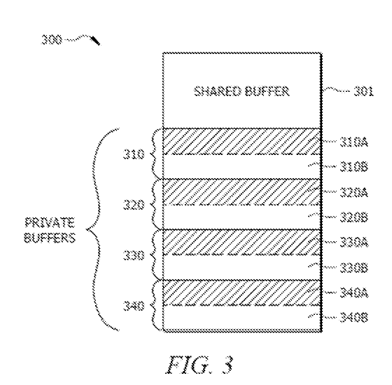

FIG. 3 shows an embodiment of an allocation of a buffer 300. The buffer 300 may be implemented in a node such as any node of FIG. 1. Buffer 300 may comprise a shared buffer 301 and a plurality of private buffers 310, 320, 330, and 340. Although only four private buffers are shown for illustrative purposes, any number of private buffers may be used in the system. A first private buffer 310 may store type 1 packets, and a second private buffer 320 may store type 2 packets. Similarly, a third private buffer 330 may store type 3 packets, and a fourth private buffer 340 may store type 4 packets. Furthermore, packets may be prioritized from highest priority packets being designated as packet type 1 through lowest priority packets being designated as packet type 4 with packet types 2 and 3 comprising intermediate priority packets accordingly, in the system implementing buffer 300. The buffer regions illustrated in FIG. 3 may be a convenient logical construct for visualizing the allocation of credits to various packet types. The buffer 300 may not in fact be partitioned into regions, but out of the total allocation of buffer space, a certain amount of space (an allocation) may be set aside for each packet type, with the space allocated to each packet type advertised to another node. The buffer 300 may be managed according to credits allocated to each packet type.

In an embodiment, a transmitter may borrow lower priority private buffer space for use as overflow for higher priority private buffers according to a priority protocol through buffer mapping (e.g. buffer mapping 200). By doing so, the transmitter may manage its upstream data flow more efficiently in the case that data of various types significantly change in relative volume. The priority protocol may permit the transmitter to use lower priority private buffer space as overflow for higher priority private buffers. For example, if a buffer credit count for the private buffer 320 has reached a minimum value (e.g., zero), the transmitter may direct a receiver to store a type 2 packet in private buffer 330 or 340. The transmitter may then decrement a buffer credit count for the lower priority private buffer chosen (e.g. private buffer 330 or 340). However, the transmitter may not direct the receiver to store the type 2 packet in private buffer 310 under the priority protocol. Thus, the transmitter may decide which private buffer the receiver will store a particular packet type unless the priority protocol is violated.

Another embodiment may comprise each of the private buffers 310-340 being further partitioned into two regions as follows: 310A, 310B, 320A, 320B, 330A, 330B, 340A, and 340B. Buffer regions 310A-340A may be portions of the private buffers subject to borrowing for use as higher priority private buffers overflow. The regions 310A-340A may continue to be referred to as “borrowable private buffers”. Buffer spaces 310B-340B may be non-borrowable regions of the private buffers that may not be borrowed for use as higher priority private buffers overflow. These buffer spaces 310B-340B may be referred to as “reserved private buffers.” The reserved private buffers 310B-340B may represent memory allocated to a packet type that may be reserved for transmission of that packet type. In this embodiment, lower priority packets (e.g. packet type 4) may still be transmitted upstream when one or more higher priority private buffers (e.g. private buffers 310-330) are experiencing overflow. Thus, the transmitter may resolve higher priority buffer overflows while saving private buffer space so that the corresponding type of packets may still be stored in its appropriate private buffer in order to keep the buffer system efficient. Although illustrated as disjoint regions, the private borrowed buffers 310B-340B may be disjoint or contiguous regions in the buffer 300.

In an embodiment, a transmitter may first use a shared buffer 301 in a receiver before borrowing lower priority private buffer space for use as overflow for higher priority private buffers according to a priority protocol through buffer mapping (e.g. buffer mapping 200). The transmitter may direct a receiver to save packet data of a given type to the region of the private buffer allocated for that data type. If the transmitter obtains more data of a given type than the amount which may be stored in the allocated space, the transmitter may direct the receiver to save such data in the shared buffer 301. Once the shared buffer 301 overflows, the transmitter may use lower priority private buffer space as overflow for higher priority private buffers according to the priority protocol. For example, if a buffer credit count for private buffer 320 has reached a minimum value (e.g., zero), the transmitter may direct the receiver to store a type 2 packet in shared buffer 301. The transmitter may then decrement a buffer credit count for the shared buffer 301. If the buffer credit count for both private buffer 320 and shared buffer 301 has reached a minimum value (e.g., zero), the transmitter may direct the receiver to store the type 2 packet in private buffer 330 or 340. The transmitter may then decrement a buffer credit count for the lower priority private buffer chosen (e.g. private buffer 330 or 340). However, the transmitter may not direct the receiver to store the type 2 packet in private buffer 310 under the priority protocol. Optionally, the transmitter may also reserve a small portion of the private buffers that may not be borrowed by any other packet type. This memory may be saved so that the corresponding type of packets may still be stored in its appropriate private buffer in order to keep the buffer system efficient. Thus, the transmitter may resort to lower priority private buffers after exhausting the corresponding private buffer space and shared buffer space.

Optionally, a shared buffer 301 may be further partitioned into a plurality of regions, similar to the private buffers. In this embodiment, packets of various priority levels may be grouped into classes under the priority protocol. For example, packet types 1 and 2 may be grouped as a class A and packet types 1-3 may be grouped as a class B. A given region of shared buffer 301 may be designated for a class so that packet transfer may be managed class by class (e.g. a region of shared buffer 301 may be reserved for class A).

The ratio of space allocated to the shared buffer 301 to the space allocated to private buffers 310-340 may be preconfigured or modified based on system needs or demands. For example, if the transmitter observes a trend that traffic becomes more unevenly spread among the different priorities, the transmitter may increase the space allocated to the shared buffer 301. Similarly, the ratio of space allocated to the private borrowed buffers 310B-340B versus the space allocated to private buffers 310A-340A may be preconfigured or modified by the transmitter based on system needs or demands.

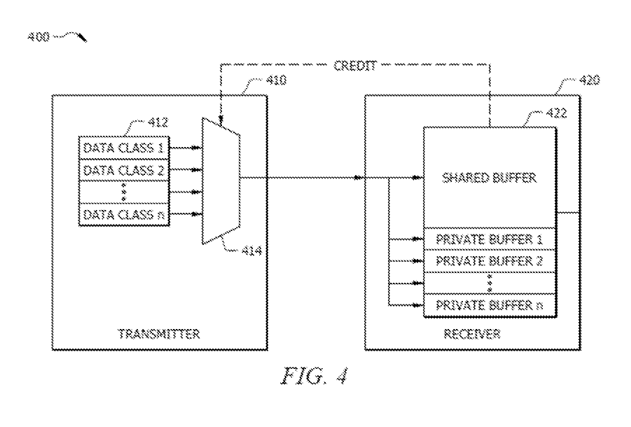

Another feature of an enhanced buffering system focuses on a priority-driven transfer of packets into a plurality of private buffers. FIG. 4 illustrates data communication between two nodes. The scheme 400 may comprise a transmitter 410 and receiver 420. The transmitter 410 may be part of a first node, and the receiver 420 may be part of a second node. The transmitter 410 may comprise a buffer 412 coupled to a multiplexer 414. The multiplexer 414 may select packets from the buffer 412 for transmission. The receiver 420 may comprise a buffer 422.

Communication between the transmitter 410 and the receiver 420 may be conducted using virtual channels. The physical channel between any two nodes (e.g., a node comprising transmitter 410 and a node comprising receiver 420) may be divided into virtual or logical channels, each of which may be used to transmit a specific packet type. Examples of a physical channel between two nodes include a wired connection, such as a wire trace dedicated for communication between the nodes or a shared bus or a wireless connection (e.g., via radio frequency communication). Virtual channels may be designated for packets of various priority levels. A given transfer channel may be assigned to a class so that packet transfer may be managed class by class. For example, virtual channels a₁, a₂ . . . aₙ may be assigned to packet class a, while virtual channels b₁, b₂ . . . bₙ may be assigned to packet class b. In another embodiment, multiple packet classes may be assigned to a single channel class.

A packet may be assigned a priority level. A high priority packet may be favored in transfer priority, which may result in early selection for transfer and/or increased channel bandwidth. Channel bandwidth as well as buffer spacing may be redistributed depending on a packet's priority level as well as the frequency of a specific type of packet in data traffic. Priority of a packet may be increased by elevating a priority index. For example, a packet class of priority 1 may use channel classes 1a and 1b, and a packet class of priority 2 may use channel classes la, 1b, 2a, and 2b. A packet class of priority n may use channel classes 1a, 1b, 2a, 2b . . . na, and nb, and so forth.

In an embodiment, packets of a higher priority may utilize transfer channels and/or private buffers that are designated for packets of a lower priority. For example, suppose a packet of priority n, where n is an integer, is transmitted (higher numbers indicate higher priority). If the private buffer for this priority is full, the transmitter may instruct the receiver to store the packet in the private buffer for the next lowest priority (i.e., priority n−1) if the private buffer for priority n−1 has space available. One means the transmitter may use to communicate this instruction to the receiver is through a designated field in a packet header. If the private buffer for priority n−1 is full, then the transmitter may instruct the receiver to store the packet in the private buffer for the next lowest priority (i.e., priority n−2) and so on. Thus, a packet of priority n can be stored in any of the private buffers designated for packets of priority 1, 2 . . . n−1, n, but not in a private buffer designated for packets of priority m>n, where m is an integer greater than n. The transmitter in such a scheme keeps a separate buffer count (or counter) for each private buffer and the shared buffer and selects a packet for transmission of a priority n according to whether there is space available in private buffers for priorities 1, 2 . . . n−1, n as indicated by the buffer counts.

Optionally some amount of a private buffer may be reserved and not borrowed by packets of a higher priority. This would ensure that lower priority packets may have some amount of buffer space to keep the lower priority packets from being blocked by higher priority packets. For example, suppose a packet of priority n is transmitted. If the private buffer for priority n packets is full the receiver may store the packet in the private buffer for the next lowest priority (i.e., priority n−1) if the private buffer for priority n−1 has space available. The receiver may reserve some space on the private buffer for priority n−1 for packets of priority n−1 and not allow packets of priority n to be stored there, in which case the receiver would check the private buffer for the next lowest priority (i.e., priority n−2), and so on.

Sharing resources among high priority packets may facilitate cache coherence transactions for temporary data storage in an interconnected network system. The aforementioned cache coherence transactions may be utilized to confirm that data is up to date among multiple caches. As packets are used in the different steps of such a transaction (e.g., from initiation to completion), the priority levels of the packets may increase accordingly. Thus, packets of high priority may utilize private buffers which are designated for packets of low priority in order to improve efficiency in a system.

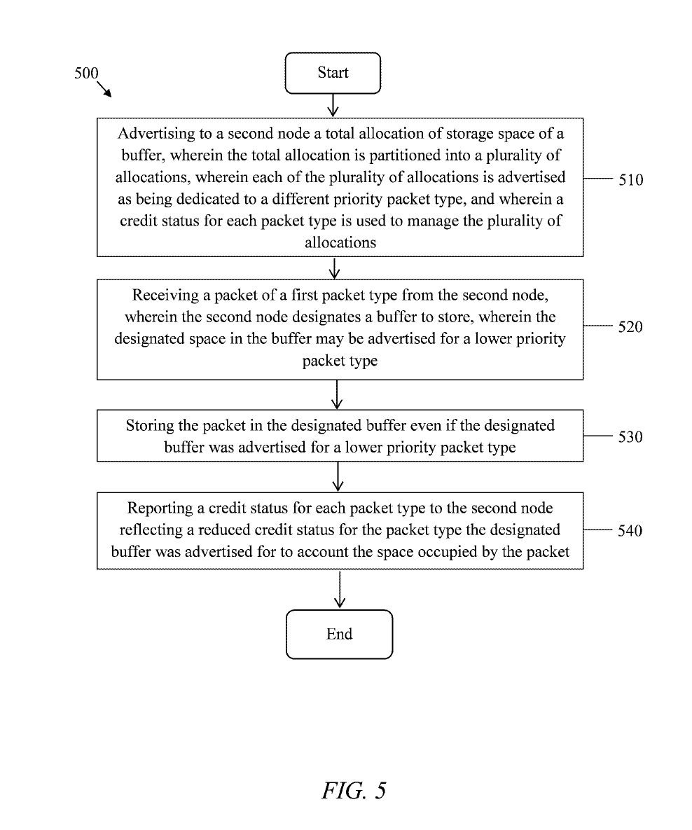

FIG. 5 is a flowchart 500 of an embodiment of a buffer space allocation method. The steps of the flowchart 500 may be implemented in a receiving node such as a node in FIG. 1. The flowchart begins is block 510, in which a receiving node may advertise to a second node a total allocation of storage space of a buffer, wherein the total allocation is partitioned into a plurality of allocations, wherein each of the plurality of allocations is advertised as being dedicated to a different priority packet type, and wherein a credit status for each packet type is used to manage the plurality of allocations. The advertising may comprise the receiver letting the sender know the available credits per packet type (which indicate the allocation per packet type). The packet type may be a priority or any other packet classification discussed herein. Next in block 520, a packet of a first packet type may be received from the second node, wherein the second node designates a buffer to store the packet, wherein the designated buffer may be advertised for a lower priority packet type. The designation by the second node may come in many forms, for example through a designated field in the header of the packet. The second node may designate any buffer that was advertised for any priority level equal to or less than the priority level of the packet. Next in block 530, the packet may be stored in the designated buffer even if the designated buffer was advertised for a lower priority packet type. That is, the packet may cause the buffer to exceed the advertised space for the first packet type, but the second node may use the advertised space for a lower priority packet type as overflow. Finally, in block 540 a credit status of the first packet type may be reported to the second node. The credit status may reflect a reduced credit status for the packet type the designated buffer was advertised for to account for the space occupied by the packet. The first node may therefore use the extra capacity of the buffer that is not advertised for the priority level of the packet to receive the packet of a priority level that would otherwise cause an overflow of the advertised space allocated to it.

Further, an embodiment may optionally include partitioning the buffer into a plurality of regions comprising a plurality of borrowable private buffers and reserved private buffers, wherein each region may be designated for a particular packet priority level. A borrowable private buffer may be used by a second node coupled to the node to send a packet of a priority level that would otherwise cause the advertised space allocated to that priority level to overflow. A reserved private buffer may be for storing a particular packet priority level and may not be used by the second node to send a packet of a different priority level. The reserved private buffer represents space that remains available to the designated priority level packets even when higher priority level buffers have overflowed.

The flowchart may be changed slightly by partitioning the buffer into a plurality of regions comprising a plurality of private buffers and a shared buffer in block 510, wherein packets of any priority level may be stored in the shared buffer. In this scenario, the second node may need to designate the shared buffer as the storage location of the packet prior to designating a buffer advertised for a lower priority packet type in block 520. Furthermore, an embodiment may optionally include partitioning the shared buffer further into a plurality of regions, wherein a plurality of packet priority levels may be grouped into classes (e.g. a highest packet priority level and an intermediate packet priority level may be grouped as a defined class). In this embodiment, a region of the shared buffer may be advertised as being dedicated to a class, wherein any packet priority levels not in that class may be precluded from being stored in that region of the shared buffer. This type of activity is described further with respect to FIG. 4.

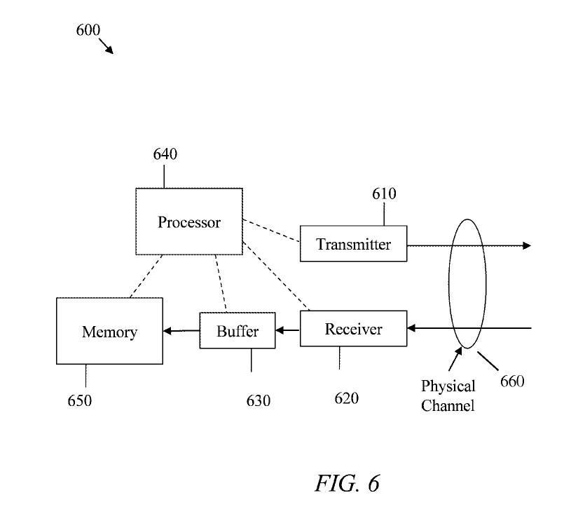

At least some of the features/methods described in the disclosure may be implemented in a network apparatus or electrical component with sufficient processing power, memory/buffer resources, and network throughput to handle the necessary workload placed upon it. For instance, the features/methods of the disclosure may be implemented using hardware, firmware, and/or software installed to run on hardware. FIG. 6 illustrates a schematic diagram of a node 600 suitable for implementing one or more embodiments of the components disclosed herein. The node 600 may comprise a transmitter 610, a receiver 620, a buffer 630, a processor 640, and a memory 650 configured as shown in FIG. 6. Although illustrated as a single processor, the processor 640 may be implemented as one or more central processing unit (CPU) chips, cores (e.g., a multi-core processor), field-programmable gate arrays (FPGAs), application specific integrated circuits (ASICs), and/or digital signal processors (DSPs). The transmitter 610 and receiver 620 may be used to transmit and receive packets, respectively, while the buffer 630 may be employed to store packets temporarily. The buffer 630 may comprise a plurality of private buffers, such as the buffer shown in FIGS. 3 and 5. The buffer 630 may optionally comprise a shared buffer and/or a private borrowed buffer as shown in FIG. 3. Packets may be forwarded from the node 600 across a physical channel 660, which may be divided into a plurality of virtual channels as described previously.

The memory 650 may comprise any of secondary storage, read only memory (ROM), and random access memory (RAM). The RAM may be any type of RAM (e.g., static RAM) and may comprise one or more cache memories. Secondary storage is typically comprised of one or more disk drives or tape drives and is used for non-volatile storage of data and as an over-flow data storage device if the RAM is not large enough to hold all working data. Secondary storage may be used to store programs that are loaded into the RAM when such programs are selected for execution. The ROM may be used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and the RAM is typically faster than to the secondary storage.

The node 600 may implement the methods and algorithms described herein, including the flowchart 500. For example, the processor 640 may control the partitioning of buffer 630 and may keep track of buffer credits. The processor 640 may instruct the transmitter 610 to send packets and may read packets received by receiver 620. Although shown as part of the node 600, the processor 640 may not be part of the node 600. For example, the processor 640 may be communicatively coupled to the node 600.

It is understood that by programming and/or loading executable instructions onto the node 600 in FIG. 6, at least one of the processor 640 and the memory 650 are changed, transforming the system 600 in part into a particular machine or apparatus having the functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means +/−10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method comprising:
receiving a credit status from a second node comprising a plurality of credits corresponding to allocations of storage space in a buffer of the second node, wherein each of the plurality of allocations are dedicated to a different packet type, and wherein the credits for each packet type are used to manage the plurality of allocations;
instructing the second node to use the credit dedicated to a second priority packet type for storing a first priority packet type, wherein the first priority is higher than the second priority, and wherein the credit status reflects the credits for the first priority packet type has reached a minimum value; and
transmitting the first priority packet to the second node.

2. The method of claim 1, wherein the second priority packet is prohibited from being stored in the allocation dedicated to the first priority packet type.

3. The method of claim 1, wherein a header field of the packet is used to instruct the second node of which packet type credit to use.

4. The method of claim 2 further comprising determining that there will be insufficient first priority packet credits and sufficient second priority packet credits for the first priority packet type, wherein the instructing of the second node to use the second priority packet credits is in response to the determining.

5. The method of claim 2, wherein a portion of the credits for each packet type are reserved for that packet type and may not be used to store any other packet type.

6. The method of claim 2, wherein the first priority packet and the second priority packet are permitted to be stored in the allocation dedicated to a third priority packet type, and wherein a third priority packet is prohibited from being stored in the allocation dedicated to the first priority packet type and the second priority packet type.

7. The method of claim 2, wherein the first priority packet and the second priority packet are part of a cache coherence transaction, and wherein the first priority packet has a higher priority than the second priority packet when the first priority packet is received after the second priority packet in the cache coherence transaction.

8. The method of claim 2, wherein the buffer is coupled to a physical channel between the second node and a first node, wherein the physical channel is divided into a plurality of virtual channels, and wherein each virtual channel is assigned to at least one packet type.

9. A method comprising:
receiving a credit status from a second node comprising a plurality of credits corresponding to allocations of storage space in a buffer of the second node, wherein a portion of the plurality of allocations are a shared allocation dedicated to a plurality of packet types, wherein a portion of the plurality of allocations are a plurality of private allocations, wherein each of the plurality of private allocations are dedicated to different packet types, and wherein the credits are used to manage the plurality of allocations;
instructing the second node to use a shared credit for storing a first priority packet of a first priority type, wherein the credit status reflects the credits for the first priority packet type has reached a minimum value; and
transmitting the first priority packet to the second node.

10. The method of claim 9, wherein the first priority packet is prohibited from being stored in the allocation dedicated to a second priority packet of a second priority type unless the shared credits have reached a minimum value, and wherein the first priority is higher than the second priority.

11. The method of claim 9, wherein the second priority packet is prohibited from being stored in the allocation dedicated to the first priority type.

12. The method of claim 10 further comprising determining that there will be insufficient first priority packet credits, insufficient shared credits, and sufficient second priority packet credits for the first priority packet type, wherein the instructing of the second node to use the second priority packet credits is in response to the determining.

13. The method of claim 9, wherein the shared allocation comprises a plurality of class allocations, wherein each of the class allocations are dedicated to a different packet class, wherein the first priority type and the second priority type are in a first packet class, wherein the first priority type, the second priority type, and a third priority type are of a second packet class, and wherein the second priority is higher than the third priority.

14. The method of claim 13, wherein a first class packet is permitted to be stored in the allocation dedicated to the first packet class.

15. The method of claim 13, wherein the second priority packet is prohibited from being stored in the allocation dedicated to the third priority type unless credits for the first packet class and the second packet class have reached a minimum value.

16. The method of claim 9, wherein a header field of the packet is used to instruct the second node of which packet type credit to use.

17. The method of claim 10, wherein the first priority packet and the second priority packet are part of a cache coherence transaction, and wherein the first priority packet has a higher priority than the second priority packet when the first priority packet is received after the second priority packet in the cache coherence transaction.

18. An apparatus comprising:
a buffer;
a receiver configured to receive a credit status from a second node comprising a plurality of credits corresponding to allocations of storage space in a second buffer of the second node, wherein a portion of the plurality of allocations are a shared allocation dedicated to a plurality of packet types, wherein a portion of the plurality of allocations are a plurality of private allocations, wherein each of the plurality of private allocations are dedicated to different packet types, and wherein the credits are used to manage the plurality of allocations; and
a transmitter coupled to the second buffer via the buffer and configured to transmit an instruction the second node to use the credit dedicated to a second priority packet type for storing a first priority packet type, wherein the first priority is higher than the second priority, and wherein the credit status reflects the credits for the first priority packet type has reached a minimum value.

19. The apparatus of claim 18 further comprising a processor coupled to the buffer and configured to determine that there will be insufficient first priority packet credits and sufficient second priority packet credits for the first priority packet type, wherein the instruction to the second node to use the second priority packet credits is in response to the determination.

20. The apparatus of claim 19, wherein a header field of the packet is used to instruct the second node of which packet type credit to use, and wherein the second priority packet is prohibited from being stored in the allocation dedicated to the first priority packet type.
